(19) United States
(12) Patent Application Publication
(10) Pub. No.: US 2010/0150571 A1
(43) Pub. Date: Jun. 17, 2010

(54) OPTICAL MODULE WITH EASILY PRODUCED FERRULE ASSEMBLY AND METHOD FOR PRODUCING THE SAME

(75) Inventors: Hiromi NAKANISHI, Yokohama-shi (JP); Toshiaki KIHARA, Yokohama-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka-shi (JP)

(21) Appl. No.: 12/634,270

(22) Filed: Dec. 9, 2009

(30) Foreign Application Priority Data
Dec. 12, 2008 (JP) 2008-317257

(51) Int. Cl. H04B 10/12; G02B 6/36; G02B 6/26

(52) U.S. Cl. 398/141; 385/78; 264/1.25

(57) ABSTRACT

An optical module with a ferrule assembly able to be easily produced is disclosed. The ferrule with a tubular shape provides first to third bores. The first bore receives the optical fiber with a sheath, the second bore receives only the glass core of the fiber, which is obtained by removing the sheath, and the third bore has a diameter substantially equal to the outer diameter of the glass core of the fiber. A resin is filled in the gap between the sheath and the third bore, and in the gap between the glass core of the fiber and the second bore. The tip of the glass core is tilted with the axis and protrudes from the end surface of the ferrule.

### BACKGROUND OF THE INVENTION

1. Field of the Invention

The present invention relates to an optical module with a ferrule assembly that is easily produced and a method to produce the optical module.

2. Related Prior Art

One type of optical modules provides a ferrule assembly including an optical fiber and a ferrule that holds and supports the optical fiber. Some Japanese Patent Applications, published as JP-2001-141957A, JP-2005-352229A and JP-H08-338930A, have disclosed such an optical module.

A ferrule assembly shown in the prior patents of JP-2001-141957A and JP-2005-352449A is assembled by processes of (1) inserting a bared optical fiber, in which a sheath is removed to expose the glass core, within the bore of the tubular ferrule, (2) cutting the glass cores along the end surface of the ferrule, and (3) polishing the end of the glass core concurrently with the end surface of the ferrule. The polish of the fiber with the ferrule forms the end surfaces thereof tilted by 4 to 8 degree with respect to the axis of the optical fiber. This tilted surface of the optical fiber and the ferrule prevents the light reflected by the end surface from returning the semiconductor device. The ferrule assembly disclosed in the prior patent of JP-H08-338930 is also polished in the end surface thereof.

However, the process to polish the end surface of the fiber and that of the ferrule has become a subject to reduce the cost of the ferrule assembly. The process applied to the conventional ferrule assembly is specifically described below. A capillary 124 made of zirconia ceramics is inserted into a metal sleeve 130 from one of the openings. The metal sleeve 130 in a deep end of the bore 130a into which the capillary is inserted is filled with a resin 126. Next, an optical fiber 122 whose sheath 122b is removed is inserted into the bore of the capillary from the other opening of the metal sleeve. In this process, the resin 126 occasionally adheres to the end of the optical fiber. Solidifying the resin as the fiber protrudes from the end surface of the capillary, cutting the fiber such that a prescribed length of the fiber is left from the end surface of the capillary, and polishing the end surface of the ferrule and that of the fiber in the same time so as to tilt the surface with respect to the axis of the fiber, the ferrule assembly is completed. In the polishing, the end surface of the ferrule and that of the metal sleeve performs a role of a fixture. Thus, the conventional process described above includes a composite procedure of the injection of the resin in to the capillary, the cut of the bared fiber, and the polish of the fiber concurrent with the ferrule and the sleeve. Moreover, these procedures are necessary to be manually preformed, which raises the cost of the ferrule assembly. The present invention may provide a ferrule assembly with a new arrangement that enables to reduce the cost thereof.

### SUMMARY OF THE INVENTION

An optical module according to the present invention comprises an optical sub-assembly (OSA) and a ferrule assembly. The OSA installs a semiconductor optical device; while, the ferrule assembly includes an optical fiber, a tubular ferrule and a resin. The optical fiber comprises a glass core and a sheath that covers the glass core, wherein the sheath is removed to expose the glass core in an end portion of the optical fiber. The ferrule provides first to third bores along the longitudinal axis of the ferrule. The third bore receives a portion the optical fiber where the sheath covers the glass core, while, the second and third bores receives a rest portion where the sheath is removed. The resin fills the second and third bores. In the present invention, the glass core has an end surface tilted to an axis of the optical fiber and protruded from an end surface of the ferrule where the first bore is formed.

The ferrule assembly of the present invention provides a gap between the optical fiber and the inner surface of the third bore; and another gap between the optical fiber and the inner surface of the second bore, where the resin is filled. On the other hand, the first bore has a diameter substantially equal to the diameter of the glass core; accordingly, the resin is prevented from filling the gap between the glass core and the inner surface of the first bore. The glass core with the tip with a tilted surface to the axis may be inserted from the third bore and protruded from the first bore, then the resin may be injected from the third bore to fix the fiber with the ferrule, which makes the polishing of the end surface of the optical fiber unnecessary after the fiber is inserted in the ferrule.

Another aspect of the present invention relates to a method to assemble the optical module. The method includes steps of: (a) assembling the ferrule assembly by (a-1) preparing an optical fiber, (a-2) inserting the prepared optical fiber into the ferrule, and (a-3) injecting a resin into the bores of the ferrule; (b) aligning the ferrule assembly optically with the semiconductor optical device; and (c) solidifying the resin.

The optical fiber prepared by step (a-1) has an end portion including a tip surface of the glass core tilted with respect to the axis of the optical fiber, wherein the sheath is removed in the end portion. The ferrule includes first to third bores. The third bore receives the portion where the sheath covers the glass core, while, the first and second bores receive the end portion of the optical fiber where the sheath is removed, at step (a-2). The tip of the glass core protrudes from the surface of the ferrule where the first bore is formed. At step (a-3), the second and third bores are injected with the resin, while, the first bore is free from the resin.

According to the method of the present invention, the optical fiber, whose tip surface is formed beforehand so as to tilt to the axis thereof, is inserted in the ferrule, and fixed thereto after the optical alignment. Thus, the method may omit the polishing of the tip surface of the glass core and that of the ferrule.

### BRIEF DESCRIPTION OF DRAWINGS

The foregoing objects and advantages of the present invention may be more readily understood by one skilled in the art with reference being had to the following detailed description of embodiments thereof, taken in conjunction with the accompanying drawings in which:

FIG. 1 is a perspective view of the optical module according to an embodiment of the invention, a portion of which is broken to show the inside thereof;

FIG. 2 is an exploded view of the optical module shown in FIG. 1;

FIG. 3 is a cross section of the ferrule assembly according to an embodiment of the invention;

FIG. 4 is an exploded view of the ferrule assembly shown in FIG. 3;

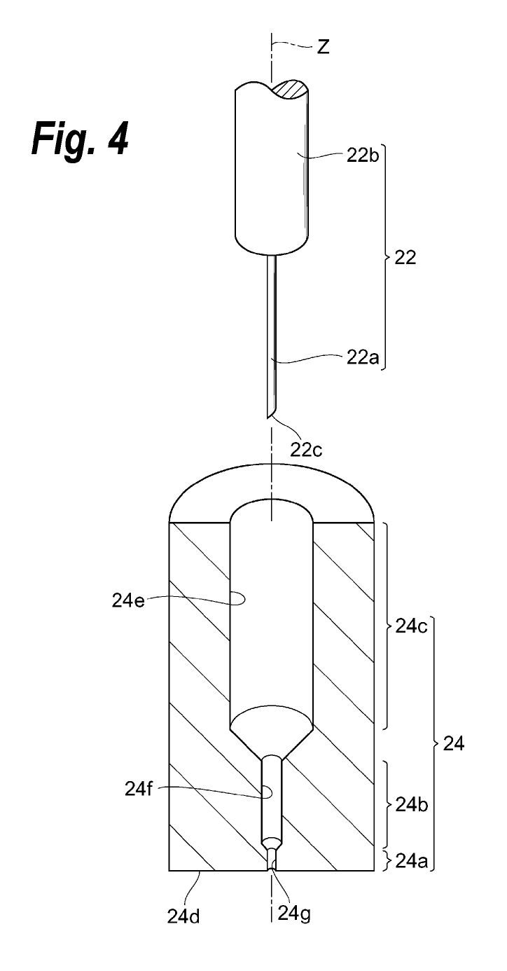

FIG. 5 shows a flow chart of the process to form the ferrule assembly shown in FIG. 4;

FIGS. 6A to 6D show process to treat the optical fiber set within the ferrule assembly shown in FIGS. 4 and 5;

FIG. 7 shows a process to insert the optical fiber into the bore of the ferrule;

FIG. 8 shows a process subsequent to the process shown in FIG. 7 to insert the optical fiber into the bore of the ferrule;

FIG. 9 shows a process to align the ferrule assembly optically with the optical devices of the LD and the PD; and

FIG. 10 schematically illustrates a process to assemble the conventional ferrule assembly.

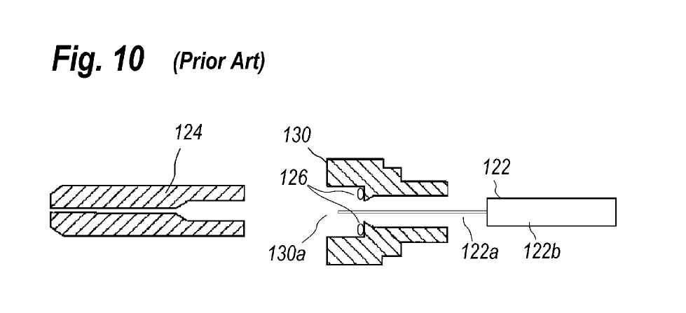

### DESCRIPTION OF PREFERRED EMBODIMENTS

Next, preferred embodiments according to the present invention will be described as referring to accompanying drawings. In the description of the drawings, the same numerals or symbols will refer to the same elements without overlapping explanations.

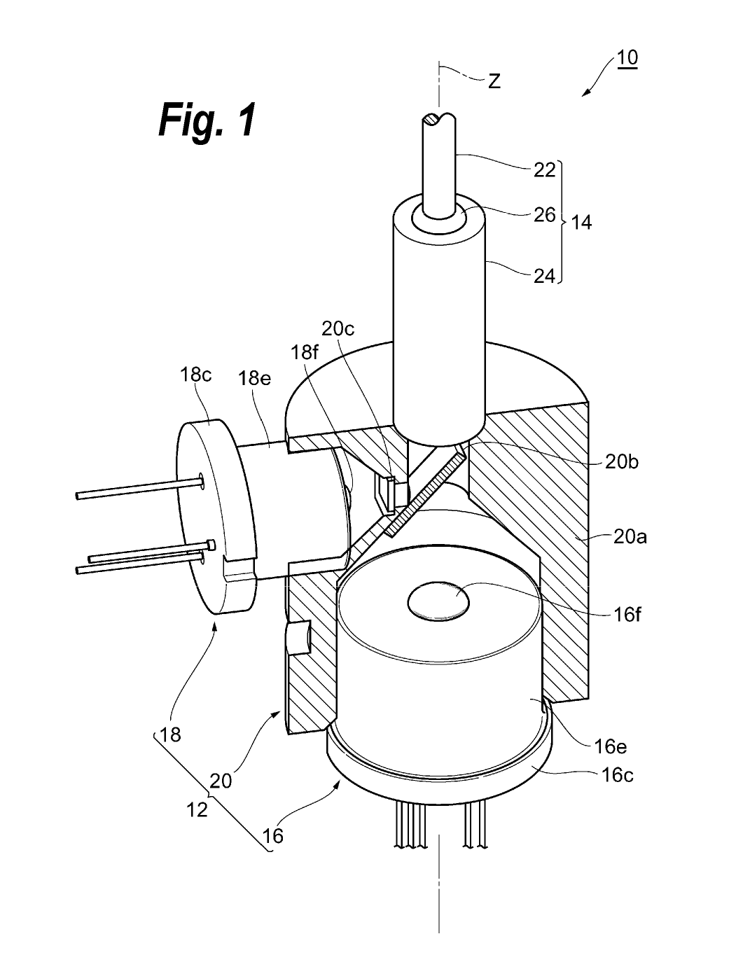

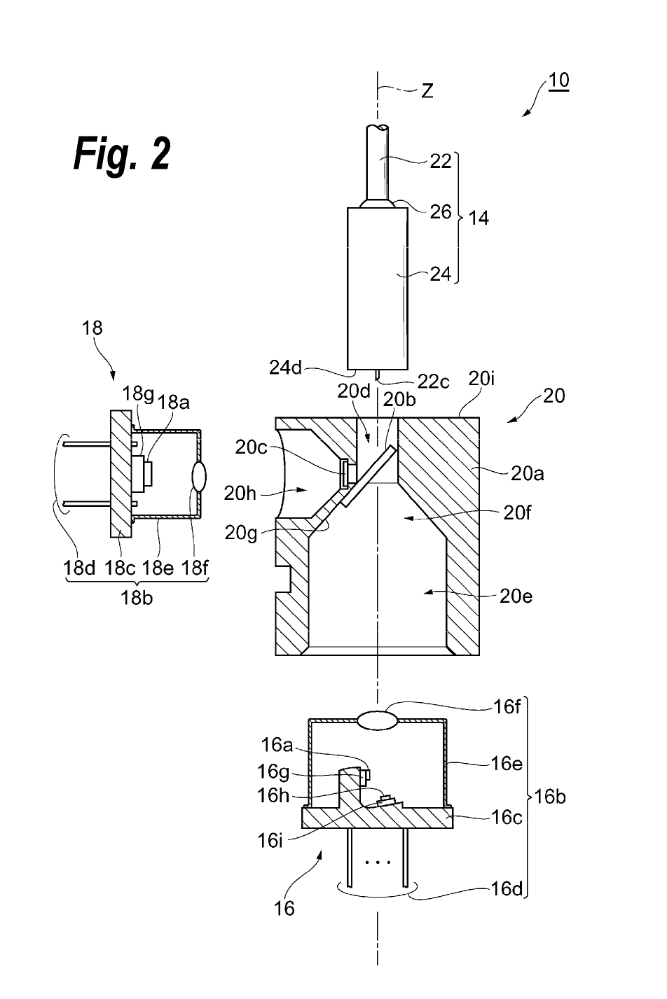

FIG. 1 is a perspective drawing of the optical module according to an embodiment of the present invention, where a portion of the optical module 10 is broken to show the inside thereof. While, FIG. 2 is an exploded view of the optical module 10, in which the optical module 10 comprises a primary unit 12 and the ferrule assembly 14. The primary unit 12 includes the first optical sub-assembly (hereafter denoted as OSA) 16, the second OSA 18, and the coupling unit 20. In the present embodiment, the first OSA 16 is a type of the transmitter optical sub-assembly (TOSA) that emits first light to the optical fiber 22 assembled within the ferrule unit 14, while, the second OSA is a type of the receiver optical sub-assembly (ROSA) that receives second light provided from the optical fiber 22. Accordingly, the optical module 10 of the present embodiment is what is called as the bi-direction optical module with the function of the optical transmitting and the optical receiving for the single fiber 22.

The first OSA 16 includes a semiconductor light-emitting device 16a, such as semiconductor laser diode (hereafter denoted as LD), and a package 16b to enclose the LD 16a therein. The package 16b includes the stem 16c, a plurality of lead pins 16d, a cap 16e and a lens 16f. On the stem 16c is mounted with the LD 16a through the sub-mount 16g. The first OSA 16 further provides a semiconductor light-receiving device 16h, such as semiconductor photodiode (hereafter denoted as PD), to monitor the light emitted from the back facet of the LD 16a. The PD 16h is also mounted on the stem 16c through the other sub-mount 16i. These semiconductor devices, the LD 16a and the PD 16h, are electrically coupled with respective lead pins 16d. Thus, the LD 16a may emit the first light by responding to an electrical signal provided through the lead pin, and the PD 16h may detect the portion of the first light and output an electrical signal corresponding to the magnitude of the first light to the outside. The first light may have a wavelength of 1.31 μm.

The cap 16e, which is a tubular shape, covers the LD 16a. One end of the cap 16e is fixed with the stem 16c, while, the other end provides the lens 16f in a center portion thereof. The lens 16f may concentrate the first light emitted from the LD 16a to focus on the end of the optical fiber 22 in the ferrule assembly 14.

The second OSA 18 provides a PD 18a and a package 18b to enclose the PD 18a therein. The package 18b includes the stem 18c, a plurality of lead pins 18d, a cap 18e and a lens 18f. The PD 18a is mounted on the stem 18c through the sub-mount 18g, and electrically connected to the lead pins 18d. The cap 18e, which has also tubular shape, encloses the PD 18a therein. One end of the cap 18e is fixed to the stem 18b, while, the other end mounts the lens 18f in a center portion thereof. Thus, the PD 18a receives the second light provided from the optical fiber 22 and with a wavelength of, for instance, 1.48 μm or 1.55 μm, focused by the lens 18f, and outputs the electrical signal corresponding to the magnitude of the second light to the lead pin 18d.

The coupling unit 20 may optically couple the first and second light with the optical fiber 22 in the ferrule assembly 14. The coupling unit 20 includes a body 20a, a wavelength division multiplexing (hereafter denoted as WDM) filter 20b, and a wavelength cutting filter 20c. The body 20a, which has substantially tubular shape with an axis Z, includes a first bore 20d and a second bore 20e along the axis Z. The diameter of the first bore 20d is less than that of the second bore 20e. The second bore 20e receives the first OSA 16. The body 20 further includes an intermediate bore 20f with a tapered cross section so as to connect the first bore 20d with the second bore 20e. The WDM filter 20b is attached to the tapered surface of the intermediate bore 20f such that the WDM filter is tilted with respect to the axis Z. The WDM filter 20b transmits the light with the first wavelength that is emitted by the first OSA 16, while, the filter 20b reflects the light with the second wavelength provided from the optical fiber 22 in the ferrule assembly 14.

In the side of the body 20a is formed with a third bore 20h that extends from the side surface to the first bore 20d. The third bore 20h receives the second OSA 18 therein. The third bore 20h also provides the wavelength cut filter 20c between the second OSA to be set therein and the first bore 20d. This wavelength cut filter 20c may transmit the light with the second wavelength, while, reflects the light with the first wavelength.

The first light emitted from the LD 16a in the first OSA is first concentrated by the lens 16f so as to focus on the end of the optical fiber 22, second passed through the WDM filter 20b, passes through the first bore 20d, and finally reaches the end of the optical fiber 22 in the ferrule assembly 14. On the other hand, the second light provided from the optical fiber 22 in the ferrule assembly 14 passes through the first bore 20d, is reflected by the WDM filter 20b, passes through the wavelength cut filter 20c, is concentrated by the lens 18f, and finally reaches the PD 18a in the second OSA 18.

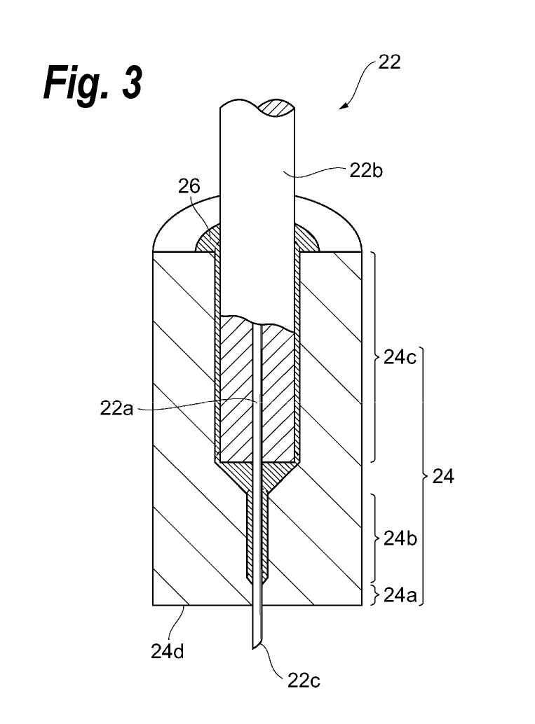

Next, the ferrule assembly 14 will be described in detail. FIG. 3 shows a cross section of the ferrule assembly 14, in which only the ferrule assembly 14 shown in FIG. 2 is extracted. The ferrule assembly 14 includes the optical fiber 22 and the ferrule 24.

The optical fiber 22 includes a glass core 22a and a sheath 22b. The sheath is removed in a portion including the tip 22c thereof. The fiber 22 has a diameter of 0.9 mm in a portion where the glass core is covered with the sheath 22b, while, the glass core 22a itself has a diameter of 0.125 mm. The tip 22c of the glass core 22a is tilted with respect the optical axis Z of the glass core 22a by an angle of 4 to 8 degree.

The ferrule 24 supports the optical fiber 22, and is a member to fix and to align the optical fiber 22 with respect to the coupling unit 20. The ferrule 24, which may be made of resin and metal, has substantially tubular shape with a center axis Z. The ferrule 24 includes, along the center axis Z, the first bore 24a, the second bore 24b and the third bore 24c, whose diameters are successively expanded in this order. Between the first and second bores, 24a and 24a, and between the second and third bores, 24b and 24c, are respectively tapered.

The third bore 24c receives the optical fiber 22 with the sheath 22b, while the second bore 24b receives only the glass core 22a, where the sheath 22b is removed. The glass core 22a further passes through the first bore 24a with the tip 22c thereof extruding from the end 24d of the first portion 24a.

A resin 26 fills the gap between the surface 24e of the third bore 24c and the sheath 22b, and between the surface 24f of the second bore 24b and the glass core 22a. Thus, the resin 26 supports and fixes the sheath 22b in the third bore 22c, and the glass core 22a in the second bore 22b. It will be explained later that the resin 26 penetrates into the second bore 24b by being injected from the gap between the sheath 22b and the inner wall 24e in the third bore 24c after it is inserted within the ferrule 24, but is necessary to be prevented from penetrating into the gap in the first bore 24a. Accordingly, the length and the diameter of the third bore 24c are set to be about 5 mm and 1.0 mm, respectively; those of the second bore 24b are about 2 mm and 0.2 mm, respectively, and those of the first bore 24a are about 0.5 mm and 0.125 mm with a tolerance of −0/+0.0005 mm. Specifically, the diameter of the first bore 24a is substantially equal to the diameter of the glass core 22a of the optical fiber 22. Such a precise adjustment of the optical fiber 22 and the bores, 24a to 24c, of the ferrule 24 makes it possible to align the tip 22a of the optical fiber 22 precisely within a range of submicron meters.

The ferrule assembly 14 is fixed with the surface 20i of the body 20a such that the end surface 24d thereof is abut against the body 20a, in which the tip 22c of the glass core 22a is set within the first bore 20d of the body 20a to couple with the LD 16 and the PD 18a optically. The end surface 20i of the body 20a is formed in substantially flat that intersects the axis Z; while, the end surface 24d of the ferrule 24 is processed in substantially flat that intersects the axis Z. Accordingly, the optical alignment of the ferrule 24 may be performed by sliding the surface 24d on the counter surface 20i, which also enables the optical alignment between the optical fiber 22 and the semiconductor optical devices, the LD 16a and the PD 18a.

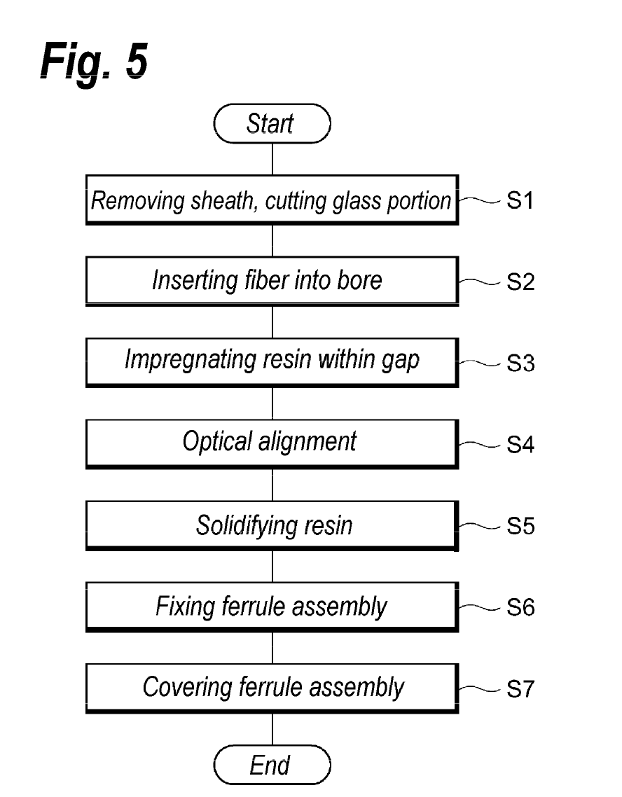

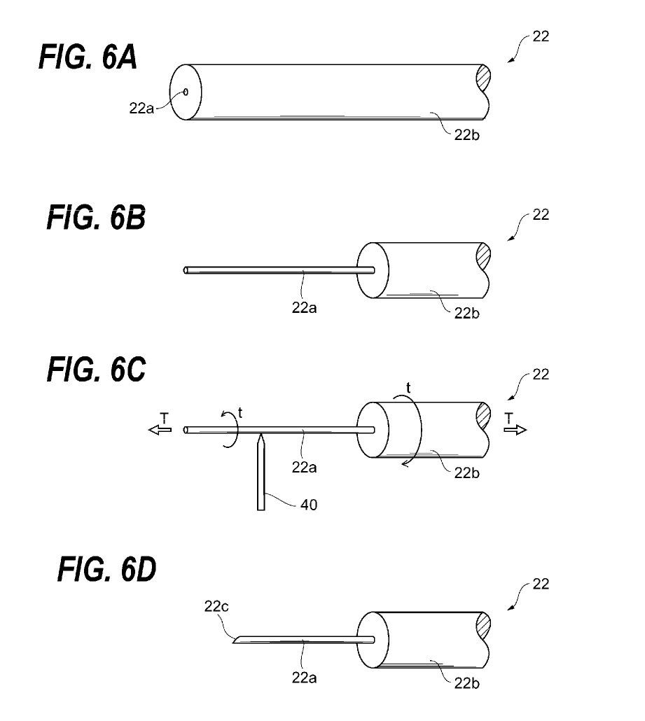

Next, a method to produce the optical module 10 according to the present embodiment will be described. FIG. 5 is a flow chart showing the process to manufacture the optical module 10. The process, as shown in FIG. 5, first removes the sheath of the optical fiber 22 and cuts the glass core thereof as step S1. FIGS. 6A to 6D show processes to assemble the optical fiber 22. As shown in FIG. 6a, the optical fiber 22 whose glass core 22a is fully covered by the sheath 22b is prepared. An end portion of the sheath 22b is removed to expose the glass core 22a with a designated length (FIG. 6B). Next, the exposed glass core 22a is twisted clockwise, while, a portion covered with the sheath 22b is twisted counterclockwise, which induces the tension T in the optical fiber 22. As keeping the tension to the optical fiber 22, the tip of the glass core with the inclined cut surface by the designated angle shown in FIG. 6D may be obtained by touching the ultrasonic cutter to the side of the glass core 22a.

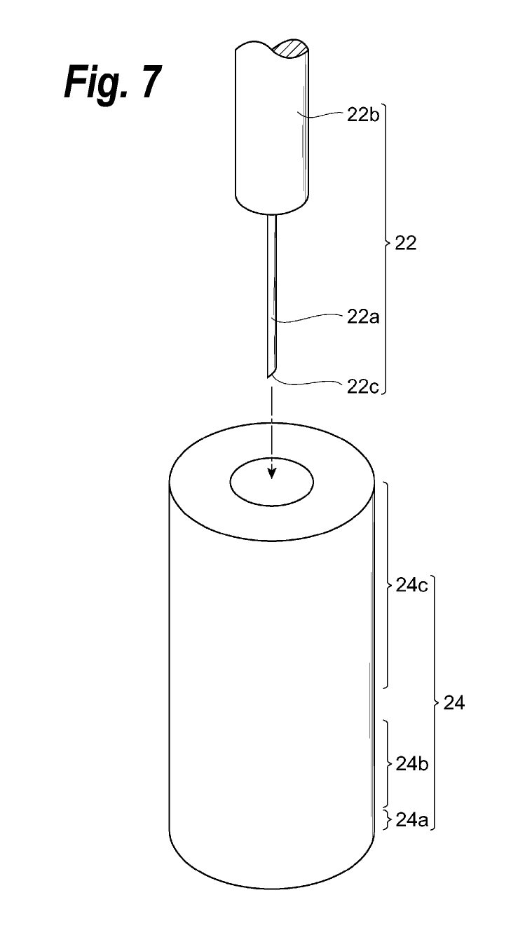

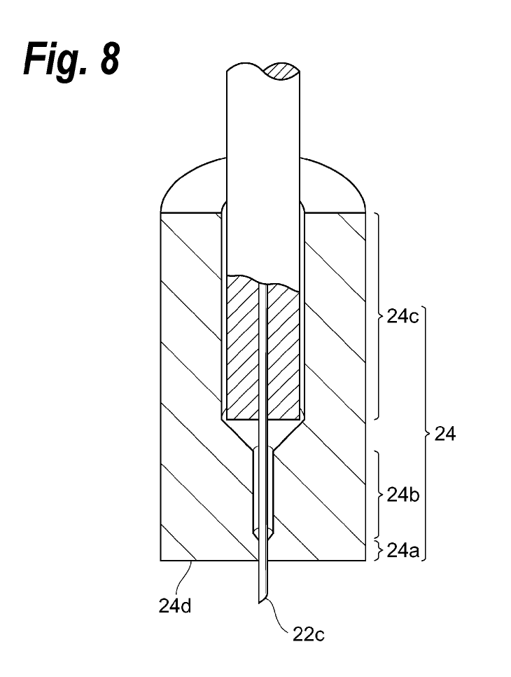

Next, the optical fiber 22 that is processed at step S/is inserted into the ferrule 24 at step S2. FIGS. 7 and 8 show processes to insert the optical fiber 22 into the ferrule 24, where FIG. 7 corresponds to a process before the insertion of the optical fiber 22; while, FIG. 8 shows the assembly after the insertion. The step S2 inserts the fiber 22 from the tip 22c thereof into the third bore 24c of the ferrule 24 until the tip 22c protrudes from the end surface 24d of the ferrule 24.

Referring back to FIG. 5, the process of the present embodiment injects a resin within the bores of the ferrule 24 at step S3. As previously described, the resin 26 is injected from the gap between the inner wall 24e of the third bore 24c and the sheath 22b. The resin 26 penetrates within the gap in the third bores 24c and that in the second bore 24b. The process shown in FIGS. 5 to 8 is unnecessary to assist the penetration of the resin by the vacuum drawing from the other side of the bores.

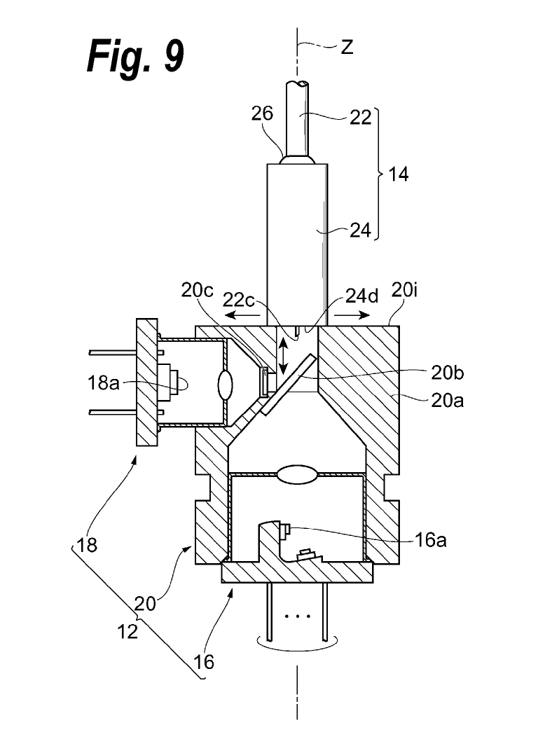

After the penetration of the resin 26, the process according to the present embodiment performs the optical alignment between the semiconductor devices such LD 16a and PD 18a and the ferrule assembly 14 at step S4. FIG. 9 illustrates the process of the optical alignment between the devices and the ferrule assembly 14. Setting the ferrule assembly 14 on the body 20a of the coupling unit as the end surface 24d faces the surface 20i of the body 20a, and sliding the ferrule assembly 14 on the surface 20i of the body 20a, the optical alignment within a plane intersecting the axis Z may be carried out. The adjustment of the position of the tip 22c within the third bore 24c may perform the optical alignment along the axis Z. The protrusion of the tip 22c may be preferably set within 0.5 mm from the end 24d of the ferrule 24.

Referring back to FIG. 5 again, after the optical alignment of the ferrule assembly 14, the process solidifies the resin at step S5, and the ferrule assembly is fixed, concurrently with the solidification, with the body 20a of the coupling unit 20 by an adhesive types of ultraviolet curable, thermo-settable or an adhesive with both characteristics. Finally, the ferrule assembly 14 is covered with a resin made boot to protect the assembly 14 (step S7).

The optical module thus described may provide the ferrule assembly 14 able to replace a conventional arrangement using, what is called, the pig-tailed fiber, because the ferrule assembly 14 according to the invention may be easily assembled which results in a cost effective module.

In the foregoing detailed description, the method and module of the present invention have been described with reference to specific exemplary embodiments thereof. It will, however, be evident that various modifications and changes may be made thereto without departing from the broader spirit and scope of the present invention. For example, the description concentrates on the bi-directional sub-assembly that provides both the TOSA and the ROSA. However, the present invention may be applicable to a mono-functional module that provides only the light transmission or the light reception. Therefore, the present specification and figures are accordingly to be regarded as illustrative rather than restrictive.

We claim:

1. An optical module comprising:
an optical subassembly that installs a semiconductor optical device; and
a ferrule assembly including,
an optical fiber providing a glass core and a sheath covering said glass core, said sheath being removed to expose said glass core in an end portion of said optical fiber,
a tubular ferrule with an axis, said ferrule providing a first bore, a second bore and a third bore along said axis, said third bore receiving a portion of said optical fiber where said sheath covers said glass core and said second and first bores receiving a rest portion of said optical fiber where said sheath is removed, and
a resin filing said second and third bores,
wherein said glass core has an end surface tilted to an axis of said optical fiber and protruded from an end surface of said ferrule where said first bore is formed.

2. The optical module of claim 1,
wherein said first bore is unfilled with said resin.

3. The optical module of claim 2,
wherein said first bore has a diameter substantially equal to a diameter of said glass core of said optical fiber.

4. The optical module of claim 1,
wherein said first bore has a diameter smaller than a diameter of said second bore, and said diameter of said second bore is smaller than a diameter of said third bore.

5. The optical module of claim 4,
wherein said first bore is connected with said second bore by an intermediate bore with a tapered surface, and said second bore is connected with said third bore by another intermediate bore with a tapered surface.

6. A bi-directional optical module, comprising:
a transmitter optical subassembly that installs a semiconductor laser diode;
a receiver optical subassembly that installs a semiconductor photodiode;
a ferrule assembly including an optical fiber with a glass core and a sheath, a tubular ferrule and a resin, said ferrule providing a first bore, a second bore and a third bore along a longitudinal axis of said ferrule, said first and second bores receiving a portion of said optical fiber where said sheath is removed and said third bore receiving another portion of said optical fiber where said sheath covers said glass core, wherein said glass core has a tip whose surface tilted to an axis of said optical fiber and protruded from an end surface of said ferrule, said resin filling said third bore and said second bore; and
a coupling unit that installs a wavelength division multiplexing filter for transmitting first light emitted from said semiconductor laser diode toward said optical fiber and reflecting second light provided from said optical fiber toward said semiconductor photodiode,
wherein said tip of said glass core positions within said coupling unit.

7. The bi-directional optical module of claim 6,
wherein said first bore of said ferrule is unfilled with said resin.

8. The bi-directional optical module of claim 7,
wherein said first bore has a diameter substantially equal to a diameter of said glass core of said optical fiber.

9. The bi-directional optical module of claim 6,
wherein said first bore has a diameter smaller than a diameter of said second bore, and said diameter of said second bore is smaller than a diameter of said third bore.

10. The bi-directional optical module of claim 9,
wherein said first bore is connected with said second bore by an intermediate bore with a tapered surface, and said second bore is connected with said third bore by another intermediate bore with a tapered surface.

11. The bi-directional optical module of claim 6,
wherein said coupling unit provides a first bore, a second bore for receiving said transmitter optical subassembly and a third bore for receiving said receiver optical subassembly, wherein said tip of said optical fiber is positioned within said first bore of said coupling unit.

12. The bi-directional optical module of claim 11,
wherein said ferrule assembly is optically aligned with said transmitter optical sub-assembly and said receiver optical subassembly on a surface where said first bore of said coupling unit is formed.

13. A method for assembling an optical module providing an optical subassembly that installs an optical semiconductor device and a ferrule assembly that includes an optical fiber, a ferrule and a resin, comprising steps of:
(a) assembling said ferrule assembly including steps of,
(a-1) preparing said optical fiber by removing a sheath to expose a glass core covered by said sheath in an end portion including a tip of said glass core and forming said tip so as to tilt to an axis of said optical fiber,
(a-2) inserting said optical fiber into a ferrule, wherein said ferrule provides first to third portions along a longitudinal axis of said ferrule, said optical fiber being inserted from said third bore and said tip protruding from an end surface where said first bore is formed, and
(a-3) injecting resin in said second bore and said third bore;
(b) aligning said tip optically to said semiconductor optical device; and
(c) solidifying said resin.

14. The method of claim 13,
wherein said step for injecting said resin is preformed so as not to inject said resin in said first bore of said ferrule.

15. The method of claim 13,
wherein said step (b) for optically aligning said tip of said optical fiber including steps of:
(b-1) sliding said ferrule assembly on a surface of a unit where said optical subassembly is installed,
(b-2) adjusting a tip position of said optical fiber along said axis thereof, and
(b-3) iterating said steps (b-1) and (b-2) until prescribed optical coupling efficiency is obtained between said semiconductor optical device and said optical fiber.

16. The method of claim 13,
where said step (a-1) for preparing said optical fiber includes steps of;
removing said sheath in said end portion,
twisting said optical fiber by rotating said glass core in said end portion clockwise or rotating a rest portion of said optical fiber where said sheath covers said glass core counterclockwise, and
touching an ultrasonic cutter to said glass core in said end portion to cut said optical fiber.
